(19) United States
(12) Patent Application Publication
(10) Pub. No.: US 2007/0298349 A1
(43) Pub. Date: Dec. 27, 2007

(54) Antireflective Coating Compositions Comprising Siloxane Polymer

(76) Inventors: Ruzhi Zhang, Pennington, NJ (US); Mark O. Neisser, Whitehouse Station, NJ (US); Woo-Kyu Kim, Bridgewater, NJ (US); David J. Abdallah, Bernardsville, NJ (US); Francis Houlihan, Millington, NJ (US); Ping-Hung Lu, Bridgewater, NJ (US); Hong Zhuang, Raritan, NJ (US)

Correspondence Address: SANGYA JAIN;AZ ELECTRONIC MATERIALS USA CORP., 70 MEISTER AVENUE, SOMERVILLE, NJ, 08876, US

(21) Appl. No.: 11/425,813

(22) Filed: Jun. 22, 2006

(51) Int. Cl. G03C 1/00

(52) U.S. Cl. 430/270.1

(57) ABSTRACT

The present invention relates to a novel antireflective coating composition for forming an underlayer for a photoresist comprising an acid generator and a novel siloxane polymer, where the siloxane polymer comprises at least one absorbing chromophore and at least one self-crosslinking functionality of structure (1),

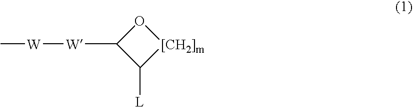

where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer. The invention also relates to a process for imaging the photoresist coated over the novel antireflective coating composition and provides good lithographic results. The invention further relates to a novel siloxane polymer, where the siloxane polymer comprises at least one absorbing chromophore and at least one self-crosslinking functionality of structure (1).

### FIELD OF INVENTION

The present invention relates to an absorbing antireflective coating composition comprising siloxane polymer, and a process for forming an image using the antireflective coating composition. The process is especially useful for imaging photoresists using radiation in the deep and extreme ultraviolet (uv) region. The invention further relates to an absorbing siloxane polymer.

### BACKGROUND OF INVENTION

Photoresist compositions are used in microlithography processes for making miniaturized electronic components such as in the fabrication of computer chips and integrated circuits. Generally, in these processes, a thin coating of film of a photoresist composition is first applied to a substrate material, such as silicon wafers used for making integrated circuits. The coated substrate is then baked to evaporate any solvent in the photoresist composition and to fix the coating onto the substrate. The photoresist coated on the substrate is next subjected to an image-wise exposure to radiation.

The radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation exposed (positive photoresist) or the unexposed areas of the photoresist (negative photoresist).

Positive working photoresists when they are exposed image-wise to radiation have those areas of the photoresist composition exposed to the radiation become more soluble to the developer solution while those areas not exposed remain relatively insoluble to the developer solution. Thus, treatment of an exposed positive-working photoresist with the developer causes removal of the exposed areas of the coating and the formation of a positive image in the photoresist coating. Again, a desired portion of the underlying surface is uncovered.

Negative working photoresists when they are exposed image-wise to radiation, have those areas of the photoresist composition exposed to the radiation become insoluble to the developer solution while those areas not exposed remain relatively soluble to the developer solution. Thus, treatment of a non-exposed negative-working photoresist with the developer causes removal of the unexposed areas of the coating and the formation of a negative image in the photoresist coating. Again, a desired portion of the underlying surface is uncovered.

Photoresist resolution is defined as the smallest feature which the photoresist composition can transfer from the photomask to the substrate with a high degree of image edge acuity after exposure and development. In many leading edge manufacturing applications today, photoresist resolution on the order of less than 100 nm is necessary. In addition, it is almost always desirable that the developed photoresist wall profiles be near vertical relative to the substrate. Such demarcations between developed and undeveloped areas of the photoresist coating translate into accurate pattern transfer of the mask image onto the substrate. This becomes even more critical as the push toward miniaturization reduces the critical dimensions on the devices.

The trend towards the miniaturization of semiconductor devices has led to the use of new photoresists that are sensitive at lower and lower wavelengths of radiation and has also led to the use of sophisticated multilevel systems, such as antireflective coatings, to overcome difficulties associated with such miniaturization.

Photoresists sensitive to short wavelengths, between about 100 nm and about 300 nm, are often used where subhalfmicron geometries are required. Particularly preferred are deep uv photoresists sensitive at below 200 nm, e.g. 193 nm and 157 nm, comprising non-aromatic polymers, a photoacid generator, optionally a dissolution inhibitor, and solvent.

The use of highly absorbing antireflective coatings in photolithography is a useful approach to diminish the problems that result from back reflection of light from highly reflective substrates. The bottom antireflective coating is applied on the substrate and then a layer of photoresist is applied on top of the antireflective coating. The photoresist is exposed imagewise and developed. The antireflective coating in the exposed area is then typically dry etched using various etching gases, and the photoresist pattern is thus transferred to the substrate. In cases where the photoresist does not provide sufficient dry etch resistance, underlayers or antireflective coatings for the photoresist that are highly etch resistant are preferred and one approach has been to incorporate silicon into these underlayers. Silicon is highly etch resistant in processes where the substrate is being etched and thus these silicon containing antireflective coatings that also absorb the exposure radiation are highly desirable.

The present invention provides for a novel antireflective coating composition for a photoresist, where the composition comprises novel silicon containing siloxane polymer which is highly absorbing and the polymer also contains a group capable of self crosslinking the polymer in the presence of an acid. The invention also provides for a process for using the antireflective coating to form an image using the novel composition. In addition to being used as an antireflective coating composition, the novel composition may also be used as a hard mask for protecting the substrate from etching gases or may also be used as a low k dielectric material. The invention further relates to a novel siloxane polymer which is highly absorbing and also contains a group capable of self crosslinking the polymer in the presence of an acid. The novel composition is useful for imaging photoresists which are coated over the novel antireflective coating composition and also for etching the substrate. The novel composition enables a good image transfer from the photoresist to the substrate, and also has good absorption characteristics to prevent reflective notching and line width variations or standing waves in the photoresist. Additionally, substantially no intermixing is present between the antireflective coating and the photoresist film. The antireflective coating also has good solution stability and forms thin films with good coating quality, the latter being particularly advantageous for lithography.

### SUMMARY OF THE INVENTION

The present invention relates to an antireflective coating composition for a photoresist comprising an acid generator and a siloxane polymer, where the siloxane polymer comprises at least one absorbing chromophore and at least one self-crosslinking functionality of structure (1),

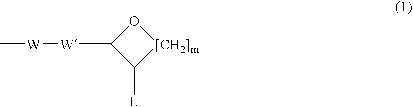

where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer. The crosslinking functionality can be selected from an epoxide or oxetane, and the chromophore can be selected from unsubstituted aromatic, substituted aromatic, unsubstituted heteroaromatic and substituted heteroaromatic moiety. The siloxane polymer may comprise at least units of (i), and/or (ii), of the structure,

(R¹SiO_{3/2}) and (R²SiO_{3/2}) (i),

(R′(R″)SiOx) (ii),

where R¹ is independently a moiety comprising a crosslinking group, R² is independently a moiety comprising a chromophore group, R′ and R″ are independently selected from R¹ and R², and x=½ or 1

The invention is also related to a process for imaging a photoresist comprising the steps of, a) forming an antireflective coating from the novel antireflective coating composition on a substrate; b) forming a coating of a photoresist over the antireflective coating; c) imagewise exposing the photoresist with an exposure equipment; and, d) developing the coating with an aqueous alkaline developer. The antireflective coating may subsequently be etched.

The invention further relates to a siloxane polymer comprising at least one absorbing chromophore and at least one crosslinking functionality of structure (1)

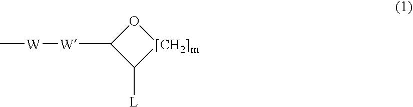

where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer. The siloxane polymer may also be one comprising at least one unit of structure (R⁵SiOₓ), where R⁵ is a moiety comprising a crosslinking group and an absorbing chromophore, and x=½, 1 or 3/2.

### BRIEF DESCRIPTION OF DRAWINGS

FIG. 1 illustrates examples of cycloaliphatic epoxides attached to the silicon unit.

FIG. 2 shows examples of aliphatic epoxides attached to the silicon unit.

FIG. 3 shows examples of silicon units with chromphore and epoxide.

FIG. 4 gives examples of unsubstituted of substituted diaryliodonium perfluoroalkanesulfonates.

FIG. 5 gives examples unsubstituted of substituted diaryliodonium tris(perfluoroalkanesulfonyl)methides.

FIG. 6 gives examples unsubstituted of substituted diaryliodonium bis(perfluoroalkane)sulfonylimides.

FIG. 7 gives examples of quaternary ammonium fluorosulfonates.

FIG. 8 gives examples of quaternary ammonium bis(perfluoroalkane)sulfonylimides.

FIG. 9 gives examples quaternary ammonium tris(perfluoroalkanesulfonyl)methide.

### DESCRIPTION OF THE INVENTION

The present invention relates to a novel antireflective coating composition for forming an underlayer for a photoresist, comprising an acid generator and a novel siloxane polymer, where the siloxane polymer comprises at least one absorbing chromophore and at least one crosslinking group of structure (1),

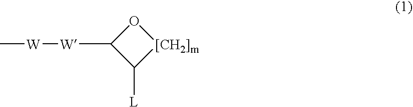

where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer. The functional group of structure (1) is capable of self-crosslinking with other similar groups to form a crosslinked polymer. The invention also relates to a process for imaging the photoresist coated over the novel antireflective coating composition and provides good lithographic results. The invention further relates to a novel siloxane polymer, where the siloxane polymer comprises at least one absorbing chromophore and at least one crosslinking functionality of structure (1), which is capable of self-crosslinking with other similar groups to form a crosslinked polymer. In one embodiment the self-crosslinking functionality of the siloxane polymer is cyclic ether, such as an epoxide or an oxetane. The chromophore in the siloxane polymer can be an aromatic functionality. The novel absorbing polymer is capable of self-crosslinking in the presence of an acid. The antireflective coating composition is useful for imaging photoresists that are sensitive to wavelength of radiation ranging from about 300 nm to about 100 nm, such as 193 nm and 157 nm.

The antireflective coating composition of the present invention comprises a siloxane polymer and an acid generator. The siloxane polymer comprises an absorbing chromophore and a crosslinking functionality of structure (1). The siloxane polymer comprising the functionality of structure (1) is capable of self-crosslinkng in the presence of an acid and so an external crosslinking compound is not required; in fact, small molecular compounds such as crosslinking agents and dyes (absorbing chromophores) can be volatilized during the processing steps and can leave residues or diffuse to an adjacent layer, and are thus less desirable. In one embodiment the novel composition is free of crosslinking agent and/or dye. A siloxane or organosiloxane polymer contains SiO units within the polymer structure, where the SiO units may be within the polymer backbone and/or pendant from the polymer backbone. Siloxane polymers known in the art may be used. Various types of siloxane polymers are known in the art and are exemplified in the following references which are incorporated herein by reference, WO 2004/113417, U.S. Pat. No. 6,069,259, U.S. Pat. No. 6,420,088, U.S. Pat. No. 6,515,073, US 2005277058 and JP 2005-221534. Examples of siloxane polymers, without limitation, are linear polymers and ladder or network (silsesquioxane) types of polymers or polymers comprising mixtures of linear and network blocks. Polyhedral structures of siloxanes are also known and are part of the invention.

In one embodiment the present siloxane polymer comprises units described by (i) and (ii),

(R¹SiO_{3/2}) and (R²SiO_{3/2}) (i),

(R′(R″)SiOx) (ii),

where R¹ is independently a moiety comprising a crosslinking group, R² is independently a moiety comprising a chromophore group, R′ and R″ are independently selected from R¹ and R², and x=½ or 1. Typically R² is a chromophore group such as an aromatic or aryl moiety. In another embodiment the siloxane polymer comprises linear polymeric units described by (iii) and (iv),

—(A¹(R¹)SiO)— (iii), and

—((A²)R²SiO)— (iv),

where, R¹ and R² are as above, A¹ and A² are independently hydroxyl, R¹ and R², halide (such as fluoride and chloride), alkyl, OR, OC(O)R, alkylketoxime, unsubstituted aryl and substituted aryl, alkylaryl, alkoxy, acyl and acyloxy, and R is selected from alkyl, unsubstituted aryl and substituted aryl. In yet another embodiment the siloxane polymer contains mixtures of network and linear units, that is, network units comprising (i) and/or (ii) and linear units comprising (iii) and/or (iv). Generally, a polymer comprising predominantly the silsesquioxane or network type of units are preferred, since they provide superior dry etch resistance, but mixtures can also be useful.

The polymer of the antireflective coating composition may further comprise one or more other silicon containing units, such as

—(R³SiO_{3/2})— (v),

where R³ is independently, hydroxyl, hydrogen, halide (such as fluoride and chloride), alkyl, OC(O)R, alkylketoxime, aryl, alkylaryl, alkoxy, acyl and acyloxy, and R is selected from alkyl, unsubstituted aryl and substituted aryl,

—(SiO_{4/2})— (vi),

—((A¹)A²SiOx) (vii),

where x=½ or 1, A¹ and A² are independently hydroxyl, hydrogen, halide (such as fluoride and chloride), alkyl, OR, OC(O)R, alkylketoxime, aryl, alkoxy, alkylaryl, acyl and acyloxy; and mixtures of these units.

In one embodiment the polymer comprises any number of units (i) to (vii), providing there is an absorbing group and a crosslinking group of structure (1) attached to a siloxane polymer. In another embodiment the polymer comprises units (i) and (v).

One example of the polymer may comprise the structure,

(R¹SiO_{3/2})ₐ(R²SiO_{3/2})_{b}(R³SiO_{3/2})_{c}(SiO_{4/2})_{d}

where, R¹ is independently a moiety comprising a crosslinking group of structure 1, R² is independently a moiety comprising a chromophore group, R³ is independently selected from hydroxyl, hydrogen, halide (such as fluoride and chloride), alkyl, OR, OC(O)R, alkylketoxime, aryl, alkylaryl, alkoxy, acyl and acyloxy; where R is selected from alkyl, unsubstituted aryl and substituted aryl; 0<a<1; 0<b<1; 0≦c<1; 0≦d<1. In one embodiment of the polymer the concentration of the monomeric units are defined by 0.1<a<0.9, 0.05<b<0.75, 0.1<c and/or d<0.8.

The novel siloxane polymer of the present composition comprises a crosslinking group, R¹, in particular cyclic ethers which are capable of crosslinking with other cyclic ether groups in the presence of acids, especially strong acids. Cyclic ethers can be exemplified by the structure (1):

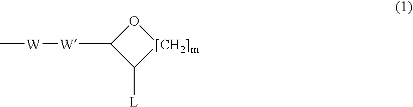

where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer. Cyclic ethers are capable of self-crosslinking to form a crosslinked polymer. The cyclic ether group is referred to as an epoxide or oxirane when m=0, and referred to as oxetane when m=1. In one embodiment the cyclic ether is an epoxide. The epoxide or oxetane may be connected directly to the silicon of the polymer. Alternatively, the cyclic ether of structure (1) may be attached to the siloxane polymer through one or more connecting group(s), W and W′. Examples of W and W′ are independently a substituted or unsubstituted (C₁-C₂₄) aryl group, a substituted or unsubstituted (C₁-C₂₀) cycloaliphatic group, a linear or branched (C₁-C₂₀) substituted or unsubstituted aliphatic alkylene group, (C₁-C₂₀) alkyl ether, (C₁-C₂₀) alkyl carboxyl, W′ and L combine to comprise a substituted or unsubstituted (C₁-C₂₀) cycloaliphatic group, and mixtures thereof. The cyclic ether may be linked to the silicon of the polymer through a combination of various types of connecting groups, that is an alkylene ether and a cycloaliphatic group, an alkylene carboxyl and a cycloaliphatic group, an alkylene ether and alkylene group, aryl alkylene group, and aryl alkylene ether group. The pendant cyclic ether crosslinking groups attached to the silicon of the polymer are exemplified in FIGS. 1-2. In one embodiment the cyclic ether crosslinking group is attached to the siloxane polymer as at least one substituted or unsubstituted biscycloaliphatic group where the cyclic ether forms a common bond (referred to as a cycloaliphatic ether), i.e. the cyclic ether shares a common bond with the cycloaliphatic group (L and W′ are linked to comprise a cyclic, preferably a cycloaliphatic, group), where the cyclic ether is preferably an epoxide (referred to as a cycloaliphatic epoxide) as shown in FIG. 1. The cycloaliphatic epoxide group may be attached to the silicon atom of the polymer either directly or through one or more connecting groups, W, as described above. Some examples of cycloaliphatic groups are substituted or unsubstituted monocyclic or substituted or unsubstituted multicyclic groups such as cyclohexyl, cycloheptyl, cyclooctyl, norbornyl, etc.

The siloxane polymer also comprises a chromophore group, R², which is an absorbing group which absorbs the radiation used to expose the photoresist, and such chromophore groups can be exemplified by aromatic functionalities or heteroaromatic functionalities. Further examples of the chromophore are without limitation, a substituted or unsubstituted phenyl group, a substituted or unsubstituted anthracyl group, a substituted or unsubstituted phenanthryl group, a substituted or unsubstituted naphthyl group, a sulfone-based compound, benzophenone-based compound, a substituted or an unsubstituted heterocyclic aromatic ring containing heteroatoms selected from oxygen, nitrogen, sulfur; and a mixture thereof. Specifically, the chromophore functionality can be bisphenylsulfone-based compounds, naphthalene or anthracene based compounds having at least one pendant group selected from hydroxy group, carboxyl group, hydroxyalkyl group, alkyl, alkylene, etc. Examples of the chromophore moiety are also given in US 2005/0058929. More specifically the chromophore may be phenyl, benzyl, hydroxyphenyl, 4-methoxyphenyl, 4-acetoxyphenyl, t-butoxyphenyl, t-butylphenyl, alkylphenyl, chloromethylphenyl, bromomethylphenyl, 9-anthracene methylene, 9-anthracene ethylene, 9-anthracene methylene, and their equivalents. In one embodiment a substituted or unsubstituted phenyl group is used.

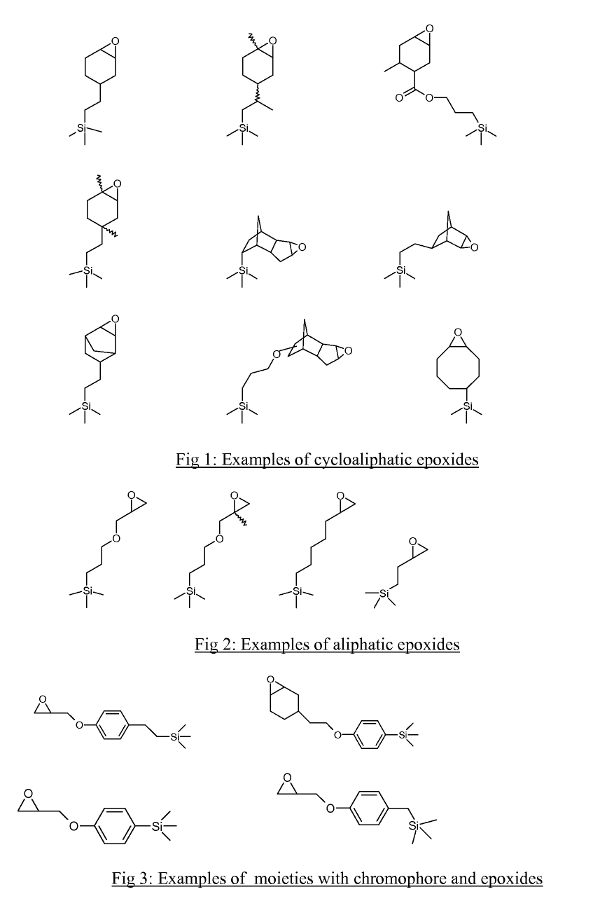

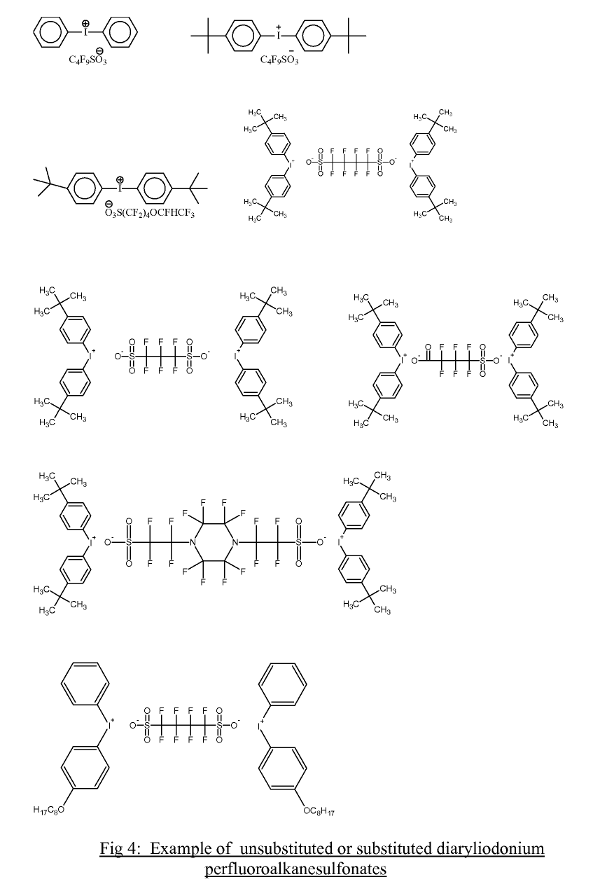

In one embodiment the crosslinking cyclic ether group and the chromophore may be within one moiety attached to the siloxane polymer backbone, where the siloxane polymer has been described previously. This moiety may be described by the structure (R⁵SiOₓ), where R⁵ is a moiety comprising a self-crosslinking cyclic ether group of structure (1) and an absorbing chromophore, and x=½, 1 or 3/2. In the polymer the aromatic chromophore group may be one described previously with pendant cyclic ether group of structure (1). As examples the pendant group could be cycloaliphatic epoxides or glycidyl epoxides. FIG. 3 shows examples of such groups. Other silicon units such as described by structures (i) to (vii) may also be present.

The polymers of this invention are polymerized to give a polymer with a weight average molecular weight from about 1,000 to about 500,000, preferably from about 2,000 to about 50,000, more preferably from about 3,000 to about 30,000.

The siloxane polymer has a silicon content of greater than 15 weight %, preferable greater than 20 weight %, and more preferably greater than 30 weight %.

In the above definitions and throughout the present specification, unless otherwise stated the terms used are described below.

Alkyl means linear or branched alkyl having the desirable number of carbon atoms and valence. The alkyl group is generally aliphatic and may be cyclic (cycloaliphatic) or acyclic (i.e. noncyclic). Suitable acyclic groups can be methyl, ethyl, n-or iso-propyl, n-, iso, or tert-butyl, linear or branched pentyl, hexyl, heptyl, octyl, decyl, dodecyl, tetradecyl and hexadecyl. Unless otherwise stated, alkyl refers to 1-10 carbon atom moeity. The cyclic alkyl (cycloaliphatic) groups may be mono cyclic or polycyclic. Suitable example of mono-cyclic alkyl groups include unsubstituted or substituted cyclopentyl, cyclohexyl, and cycloheptyl groups. The substituents may be any of the acyclic alkyl groups described herein. Suitable bicyclic alkyl groups include substituted bicycle[2.2.1]heptane, bicyclo[2.2.2]octane, bicyclo[3.2.1]octane, bicyclo[3.2.2]nonane, and bicyclo[3.3.2]decane, and the like. Examples of tricyclic alkyl groups include tricyclo[5.4.0.0.^{2,9}]undecanei, tricyclo[4.2.1.2.^{7,9}]undecane, tricyclo[5.3.2.0.^{4,}9]dodecane, and tricyclo[5.2.1.0.^{2,6}]decane. As mentioned herein the cyclic alkyl groups may have any of the acyclic alkyl groups as substituents.

Alkylene groups are divalent alkyl groups derived from any of the alkyl groups mentioned hereinabove. When referring to alkylene groups, these include an alkylene chain substituted with (C₁-C₁₀) alkyl groups in the main carbon chain of the alkylene group. Essentially an alkylene is a divalent hydrocarbon group as the backbone. Accordingly, a divalent acyclic group may be methylene, 1,1- or 1,2-ethylene, 1,1-, 1,2-, or 1,3 propylene, 2,5-dimethyl-2,5-hexene, 2,5-dimethyl-2,5-hex-3-yne, and so on. Similarly, a divalent cyclic alkyl group may be 1,2- or 1,3-cyclopentylene, 1,2-, 1,3-, or 1,4-cyclohexylene, and the like. A divalent tricyclo alkyl groups may be any of the tricyclic alkyl groups mentioned herein above. A particularly useful tricyclic alkyl group in this invention is 4,8-bis(methylene)-tricyclo[5.2.1.0.^{2,6}]decane.

Aryl or aromatic groups contain 6 to 24 carbon atoms including phenyl, tolyl, xylyl, naphthyl, anthracyl, biphenyls, bis-phenyls, tris-phenyls and the like. These aryl groups may further be substituted with any of the appropriate substituents e.g. alkyl, alkoxy, acyl or aryl groups mentioned hereinabove. Similarly, appropriate polyvalent aryl groups as desired may be used in this invention. Representative examples of divalent aryl groups include phenylenes, xylylenes, naphthylenes, biphenylenes, and the like.

Alkoxy means straight or branched chain alkoxy having 1 to 10 carbon atoms, and includes, for example, methoxy, ethoxy, n-propoxy, isopropoxy, n-butoxy, isobutoxy, tert-butoxy, pentyloxy, hexyloxy, heptyloxy, octyloxy, nonanyloxy, decanyloxy, 4-methylhexyloxy, 2-propylheptyloxy, 2-ethyloctyloxy and phenyloxy.

Aralkyl means aryl groups with attached substituents. The substituents may be any such as alkyl, alkoxy, acyl, etc. Examples of monovalent aralkyl having 7 to 24 carbon atoms include phenylmethyl, phenylethyl, diphenylmethyl, 1,1- or 1,2-diphenylethyl, 1,1-, 1,2-, 2,2-, or 1,3-diphenylpropyl, and the like. Appropriate combinations of substituted aralkyl groups as described herein having desirable valence may be used as a polyvalent aralkyl group.

Furthermore, and as used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. Illustrative substituents include, for example, those described hereinabove. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

The novel siloxane polymer may be synthesized as known in the art. Typically the siloxane polymer is made by reacting a compound containing the silicon unit(s) or silane(s), and water in the presence of a hydrolysis catalyst to form the siloxane polymer. The ratio of the various types of substituted and unsubstituted silanes used to form the novel siloxane polymer is varied to provide a polymer with the desirable structure and properties. The silane compound containing the chromophoric unit can vary from about 5 mole % to about 90 mole %, preferably from about 5 mole % to about 75 mole %; the silane compound containing the crosslinking unit can vary from about 5 mole % to about 90 mole %, preferably from about 10 mole % to about 90 mole %. The hydrolysis catalyst can be a base or an acid, exemplified by mineral acid, organic carboxylic acid, organic quaternary ammonium base. Further example of specific catalyst are acetic acid, propionic acid, phosphoric acid, or tetramethylammonium hydroxide. The reaction may be heated at a suitable temperature for a suitable length of time till the reaction is complete. Reaction temperatures can range from about 25° C. to about 170° C. The reaction times can range from about 10 minutes to about 24 hours. Additional organic solvents may be added to solubilize the silane in water, such solvents which are water miscible solvents (e.g. tetrahydrofuran and propyleneglycol monomethylether acetate (PGMEA)) and lower (C₁-C₅) alcohols, further exemplified by ethanol, isopropanol, 2-ethoxyethanol, and 1-methoxy-2-propanol. The organic solvent can range from 5 weight % to about 90 weight %. Other methods of forming the siloxane polymer may also be used, for example suspension in aqueous solution or emulsion in aqueous solution. The silanes may contain the self-crosslinking functionality and the chromophore in the monomers or may be incorporated into a formed siloxane polymer by reacting it with the compound or compounds containing the functionality or functionalities. The silanes may contain other groups such as halides, hydroxyl, OC(O)R, alkylketoxime, aryl, alkylaryl, alkoxy, acyl and acyloxy; where R is selected from alkyl, unsubstituted aryl and substituted aryl, which are the unreacted substituents of the silane monomer. The novel polymer may contain unreacted and/or hydrolysed residues from the silanes, that is, silicon with end groups such as hydroxyl, hydrogen, halide (e.g. chloride or fluoride), acyloxy, or OR^{a}, where R^{a} is selected from (C₁-C₁₀) alkyl, C(O)R^{b}, NR^{b}(R^{c}) and aryl, and R^{b} and R^{c} are independently (C₁-C₁₀) or aryl. These residues could be of the structure, (XSi(Y)Oₓ) where X and Y are independently selected from OH, H, OSi—, OR^{a}, where R^{a} is selected from (C₁-C₁₀) alkyl, unsubstituted aryl, substituted aryl, C(O)R^{b}, NR^{b}(R^{c}), halide, acyloxy, acyl, oxime, and aryl, and R^{b} and R^{c} are independently (C₁-C₁₀) or aryl, Y can also be R¹ and/or R² (as described previously), and x=½ or 1.

Silicon-containing antireflective coating materials are typically synthesized from a variety of silane reactants including, for example:

(a) dimethoxysilane, diethoxysilane, dipropoxysilane, diphenyloxysilane, methoxyethoxysilane, methoxypropoxysilane, methoxyphenyloxysilane, ethoxypropoxysilane, ethoxyphenyloxysilane, methyl dimethoxysilane, methyl methoxyethoxysilane, methyl diethoxysilane, methyl methoxypropoxysilane, methyl methoxyphenyloxysilane, ethyl dipropoxysilane, ethyl methoxypropoxysilane, ethyl diphenyloxysilane, propyl dimethoxysilane, propyl methoxyethoxysilane, propyl ethoxypropoxysilane, propyl diethoxysilane, propyl diphenyloxysilane, butyl dimethoxysilane, butyl methoxyethoxysilane, butyl diethoxysilane, butyl ethoxypropoxysilane, butyl dipropoxysilane, butyl methylphenyloxysilane, dimethyl dimethoxysilane, dimethyl methoxyethoxysilane, dimethyl diethoxysilane, dimethyl diphenyloxysilane, dimethyl ethoxypropoxysilane, dimethyl dipropoxysilane, diethyl dimethoxysilane, diethyl methoxypropoxysilane, diethyl diethoxysilane, diethyl ethoxypropoxysilane, dipropyl dimethoxysilane, dipropyl diethoxysilane, dipropyl diphenyloxysilane, dibutyl dimethoxysilane, dibutyl diethoxysilane, dibutyl dipropoxysilane, dibutyl methoxyphenyloxysilane, methyl ethyl dimethoxysilane, methyl ethyl diethoxysilane, methyl ethyl dipropoxysilane, methyl ethyl diphenyloxysilane, methyl propyl dimethoxysilane, methyl propyl diethoxysilane, methyl butyl dimethoxysilane, methyl butyl diethoxysilane, methyl butyl dipropoxysilane, methyl ethyl ethoxypropoxysilane, ethyl propyl dimethoxysilane, ethyl propyl methoxyethoxysilane, dipropyl dimethoxysilane, dipropyl methoxyethoxysilane, propyl butyl dimethoxysilane, propyl butyl diethoxysilane, dibutyl methoxyethoxysilane, dibutyl methoxypropoxysilane, dibutyl ethoxypropoxysilane, trimethoxysilane, triethoxysilane, tripropoxysilane, triphenyloxysilane, dimethoxymonoethoxysilane, diethoxymonomethoxysilane, dipropoxymonomethoxysilane, dipropoxymonoethoxysilane, diphenyloxymonomethoxysilane, diphenyloxymonoethoxysilane, diphenyloxymonopropoxysilane, methoxyethoxypropoxysilane, monopropoxydimethoxysilane, monopropoxydiethoxysilane, monobutoxydimethoxysilane, monophenyloxydiethoxysilane, methyl trimethoxysilane, methyl triethoxysilane, methyl tripropoxysilane, ethyl trimethoxysilane, ethyl tripropoxysilane, ethyl triphenyloxysilane, propyl trimethoxysilane, propyl triethoxysilane, propyl triphenyloxysilane, butyl trimethoxysilane, butyl triethoxysilane, butyl tripropoxysilane, butyl triphenyloxysilane, methyl monomethoxydiethoxysilane, ethyl monomethoxydiethoxysilane, propyl monomethoxydiethoxysilane, butyl monomethoxydiethoxysilane, methyl monomethoxydipropoxysilane, methyl monomethoxydiphenyloxysilane, ethyl monomethoxydipropoxysilane, ethyl monomethoxy diphenyloxysilane, propyl monomethoxydipropoxysilane, propyl monomethoxydiphenyloxysilane, butyl monomethoxy dipropoxysilane, butyl monomethoxydiphenyloxysilane, methyl methoxyethoxypropoxysilane, propyl methoxyethoxy propoxysilane, butyl methoxyethoxypropoxysilane, methyl monomethoxymonoethoxybutoxysilane, ethyl monomethoxymonoethoxy monobutoxysilane, propyl monomethoxymonoethoxy monobutoxysilane, butyl monomethoxymonoethoxy monobutoxysilane, tetramethoxysilane, tetraethoxysilane, tetrapropoxysilane, tetrabutoxysilane, tetraphenyloxysilane, trimethoxymonoethoxysilane, dimethoxydiethoxysilane, triethoxymonomethoxysilane, trimethoxymonopropoxysilane, monomethoxytributoxysilane, monomethoxytriphenyloxysilane, dimethoxydipropoxysilane, tripropoxymonomethoxysilane, trimethoxymonobutoxysilane, dimethoxydibutoxysilane, triethoxymonopropoxysilane, diethoxydipropoxysilane, tributoxymonopropoxysilane, dimethoxymonoethoxy monobutoxysilane, diethoxymonomethoxy monobutoxysilane, diethoxymonopropoxymonobutoxysilane, dipropoxymonomethoxy monoethoxysilane, dipropoxymonomethoxy monobutoxysilane, dipropoxymonoethoxymonobutoxysilane, dibutoxymonomethoxy monoethoxysilane, dibutoxymonoethoxy monopropoxysilane and monomethoxymonoethoxymonopropoxy monobutoxysilane, and oligomers thereof.

(b) Halosilanes, including chlorosilanes, such as trichlorosilane, methyltrichlorosilane, ethyltrichlorosilane, phenyltrichlorosilane, tetrachlorosilane, dichlorosilane, methyldichlorosilane, dimethyldichlorosilane, chlorotriethoxysilane, chlorotrimethoxysilane, chloromethyltriethoxysilane, chloroethyltriethoxysilane, chlorophenyltriethoxysilane, chloromethyltrimethoxysilane, chloroethyltrimethoxysilane, and chlorophenyltrimethoxysilane are also used as silane reactants. In addition, silanes that can undergo hydrolysis and condensation reactions such as acyloxysilanes, or alkylketoximesilanes, are also used as silane reactants.

(c) Silanes bearing epoxy functionality, include 2-(3,4-epoxycyclohexyl)ethyl-trimethoxysilane, 2-(3,4-epoxycyclohexyl)ethyl-triethoxysilane, 2-(3,4-epoxycyclohexyl)ethyl-tripropoxysilane, 2-(3,4-epoxycyclohexyl)ethyl-triphenyloxysilane, 2-(3,4-epoxycyclohexyl)ethyl-diethoxymethoxysilane, 2-(3,4-epoxycyclohexyl)ethyl-dimethoxyethoxysilane, 2-(3,4-epoxycyclohexyl)ethyl-trichlorosilane, 2-(3,4-epoxycyclohexyl)ethyl-triacetoxysilane, (glycidyloxypropyl)-trimethoxysilane, (glycidyloxypropyl)-triethoxysilane, (glycidyloxypropyl)-tripropoxysilane, (glycidyloxypropyl)-triphenyloxysilane, (glycidyloxypropyl)-diethoxymethoxysilane, (glycidyloxypropyl)-dimethoxyethoxysilane, (glycidyloxypropyl)-trichlorosilane, and (glycidyloxypropyl)-triacetoxysilane

(d) Silanes bearing chromophore functionality, include phenyl dimethoxysilane, phenyl methoxyethoxysilane, phenyl diethoxysilane, phenyl methoxypropoxysilane, phenyl methoxyphenyloxysilane, phenyl dipropoxysilane, anthracyl dimethoxysilane, anthracyl diethoxysilane, methyl phenyl dimethoxysilane, methyl phenyl diethoxysilane, methyl phenyl dipropoxysilane, methyl phenyl diphenyloxysilane, ethyl phenyl dimethoxysilane, ethyl phenyl diethoxysilane, methyl anthracyl dimethoxysilane, ethyl anthracyl diethoxysilane, propyl anthracyl dipropoxysilane, methyl phenyl ethoxypropoxysilane, ethyl phenyl methoxyethoxysilane, diphenyl dimethoxysilane, diphenyl methoxyethoxysilane, phenyl trimethoxysilane, phenyl triethoxysilane, phenyl tripropoxysilane, anthracyl trimethoxysilane, anthracyl tripropoxysilane, phenyl triphenyloxysilane, phenyl monomethoxydiethoxysilane, anthracyl monomethoxydiethoxysilane, phenyl monomethoxydipropoxysilane, phenyl monomethoxydiphenyloxysilane, anthracyl monomethoxydipropoxysilane, anthracyl monomethoxy diphenyloxysilane, phenyl methoxyethoxypropoxysilane, anthracyl methoxyethoxypropoxysilane, phenyl monomethoxymonoethoxymonobutoxysilane, and anthracyl monomethoxymonoethoxymonobutoxysilane, and oligomers thereof.

Preferred among these compounds are triethoxysilane, tetraethoxysilane, methyltriethoxysilane, dimethyldiethoxysilane, tetramethoxysilane, methyltrimethoxysilane, trimethoxysilane, dimethyldimethoxysilane, phenyltriethoxysilane, phenyltrimethoxysilane, diphenyldiethoxysilane, diphenyldimethoxysilane, 2-(3,4-epoxycyclohexyl)ethyl-trimethoxysilane, 2-(3,4-epoxycyclohexyl)ethyl-triethoxysilane, (glycidyloxypropyl)-trimethoxysilane, (glycidyloxypropyl)-triethoxysilane, phenyl trimethoxysilane, phenyl triethoxysilane, and phenyl tripropoxysilane. In another embodiment the preferred monomers are triethoxysilane, tetraethoxysilane, methyltriethoxysilane, tetramethoxysilane, methyltrimethoxysilane, trimethoxysilane, phenyltriethoxysilane, phenyltrimethoxysilane, diphenyldiethoxysilane, and diphenyldimethoxysilane, 2-(3,4-epoxycyclohexyl)ethyl-trimethoxysilane, 2-(3,4-epoxycyclohexyl)ethyl-triethoxysilane.

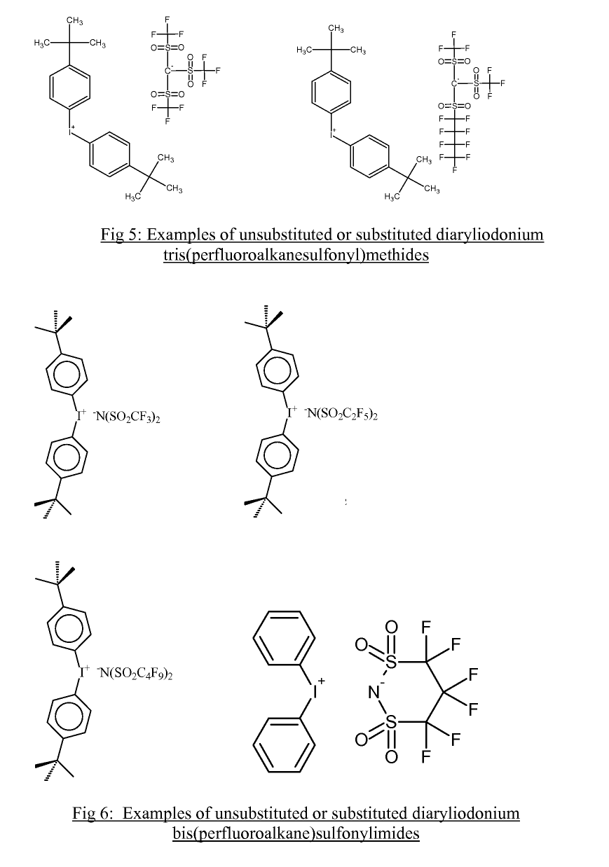

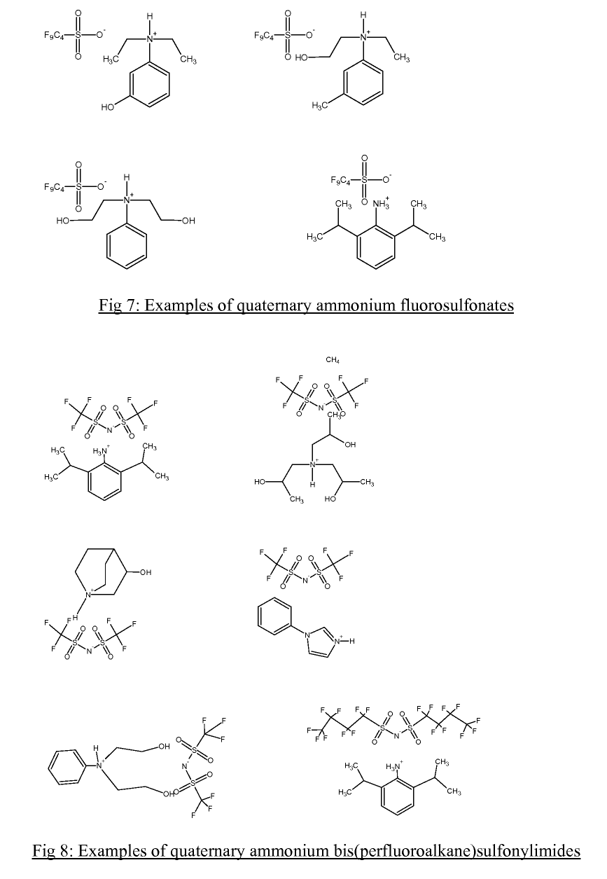

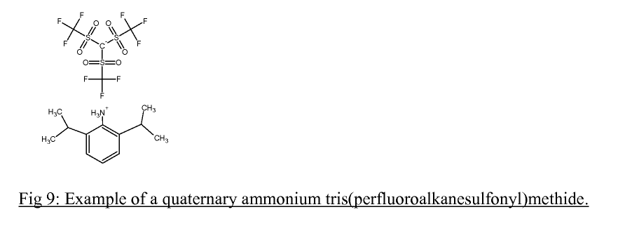

The acid generator of the novel composition is a thermal acid generator capable of generating a strong acid upon heating. The thermal acid generator (TAG) used in the present invention may be any one or more that upon heating generates an acid which can react with the cyclic ether and propagate crosslinking of the polymer present in the invention, particularly preferred is a strong acid such as a sulfonic acid. Preferably, the thermal acid generator is activated at above 90° C. and more preferably at above 120° C., and even more preferably at above 150° C. The photoresist film is heated for a sufficient length of time to react with the coating. Examples of thermal acid generators are metal-free iodonium and sulfonium salts, such as in FIG. 4. Examples of TAGs are nitrobenzyl tosylates, such as 2-nitrobenzyl tosylate, 2,4-dinitrobenzyl tosylate, 2,6-dinitrobenzyl tosylate, 4-nitrobenzyl tosylate; benzenesulfonates such as 2-trifluoromethyl-6-nitrobenzyl 4-chlorobenzenesulfonate, 2-trifluoromethyl-6-nitrobenzyl 4-nitro benzenesulfonate; phenolic sulfonate esters such as phenyl, 4-methoxybenzenesulfonate; alkyl ammonium salts of organic acids, such as triethylammonium salt of 10-camphorsulfonic acid. Iodonium salts are preferred and can be exemplified by iodonium fluorosulfonates, iodonium tris(fluorosulfonyl)methide, iodonium bis(fluorosulfonyl)methide, iodonium bis(fluorosulfonyl)imide, iodonium quaternary ammonium fluorosulfonate, iodonium quaternary ammonium tris(fluorosulfonyl)methide, and iodonium quaternary ammonium bis(fluorosulfonyl)imide. A variety of aromatic (anthracene, naphthalene or benzene derivatives) sulfonic acid amine salts can be employed as the TAG, including those disclosed in U.S. Pat. Nos. 3,474,054, 4,200,729, 4,251,665 and U.S. Pat. No. 5,187,019. Preferably the TAG will have a very low volatility at temperatures between 170-220° C. Examples of TAGs are those sold by King Industries under Nacure and CDX names. Such TAG's are Nacure 5225, and CDX-2168E, which is a dodecylbenzene sulfonic acid amine salt supplied at 25-30% activity in propylene glycol methyl ether from King Industries, Norwalk, Conn. 06852, USA. Strong acids with pKa in the range of about −1 to about −16 are preferred, and strong acids with pKa in the range of about −10 to about −16 are more preferred.

The antireflection coating composition of the present invention contains 1 weight % to about 15 weight % of the siloxane polymer, and preferably 4 weight % to about 10 weight % of total solids. The thermal acid generator, may be incorporated in a range from about 0.1 to about 10 weight % by total solids of the antireflective coating composition, preferably from 0.3 to 5 weight % by solids, and more preferably 0.5 to 2.5 weight % by solids.

The solid components of the antireflection coating composition are mixed with a solvent or mixtures of solvents that dissolve the solid components of the antireflective coating. Suitable solvents for the antireflective coating composition may include, for example, a glycol ether derivative such as ethyl cellosolve, methyl cellosolve, propylene glycol monomethyl ether, diethylene glycol monomethyl ether, diethylene glycol monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate; carboxylates such as ethyl acetate, n-butyl acetate and amyl acetate; carboxylates of di-basic acids such as diethyloxylate and diethylmalonate; dicarboxylates of glycols such as ethylene glycol diacetate and propylene glycol diacetate; and hydroxy carboxylates such as methyl lactate, ethyl lactate, ethyl glycolate, and ethyl-3-hydroxy propionate; a ketone ester such as methyl pyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; lactones such as butyrolactone; an amide derivative such as dimethylacetamide or dimethylformamide, anisole, and mixtures thereof.

The novel composition may further contain a photoacid generator, examples of which without limitation, are onium salts, sulfonate compounds, nitrobenzyl esters, triazines, etc. The preferred photoacid generators are onium salts and sulfonate esters of hydoxyimides, specifically diphenyl iodnium salts, triphenyl sulfonium salts, dialkyl iodonium salts, triakylsulfonium salts, and mixtures thereof.

The antireflective coating composition comprises the polymer, and the thermal acid generator of the instant invention and a suitable solvent or mixtures of solvents. Other components may be added to enhance the performance of the coating, e.g. monomeric dyes, lower alcohols, crosslinking agents, surface leveling agents, adhesion promoters, antifoaming agents, etc.

Since the antireflective film is coated on top of the substrate and is further subjected to dry etching, it is envisioned that the film is of sufficiently low metal ion level and of sufficient purity that the properties of the semiconductor device are not adversely affected. Treatments such as passing a solution of the polymer through an ion exchange column, filtration, and extraction processes can be used to reduce the concentration of metal ions and to reduce particles.

The absorption parameter (k) of the novel composition ranges from about 0.05 to about 1.0, preferably from about 0.1 to about 0.8 as measured using ellipsometry. The refractive index (n) of the antireflective coating is also optimized and can range from 1.3 to about 2.0, preferably 1.5 to about 1.8. The n and k values can be calculated using an ellipsometer, such as the J. A. Woollam WVASE VU-32™ Ellipsometer. The exact values of the optimum ranges for k and n are dependent on the exposure wavelength used and the type of application. Typically for 193 nm the preferred range for k is 0.05 to 0.75, and for 248 nm the preferred range for k is 0.15 to 0.8.

The antireflective coating composition is coated on the substrate using techniques well known to those skilled in the art, such as dipping, spin coating or spraying. The film thickness of the antireflective coating ranges from about 15 nm to about 200 nm. The coating is further heated on a hot plate or convection oven for a sufficient length of time to remove any residual solvent and induce crosslinking, and thus insolubilizing the antireflective coating to prevent intermixing between the antireflective coatings. The preferred range of temperature is from about 90° C. to about 250° C. If the temperature is below 90° C. then insufficient loss of solvent or insufficient amount of crosslinking takes place, and at temperatures above 300° C. the composition may become chemically unstable. A film of photoresist is then coated on top of the uppermost antireflective coating and baked to substantially remove the photoresist solvent. An edge bead remover may be applied after the coating steps to clean the edges of the substrate using processes well known in the art.

The substrates over which the antireflective coatings are formed can be any of those typically used in the semiconductor industry. Suitable substrates include, without limitation, silicon, silicon substrate coated with a metal surface, copper coated silicon wafer, copper, aluminum, polymeric resins, silicon dioxide, metals, doped silicon dioxide, silicon nitride, tantalum, polysilicon, ceramics, aluminum/copper mixtures; gallium arsenide and other such Group III/V compounds. The substrate may comprise any number of layers made from the materials described above.

Photoresists can be any of the types used in the semiconductor industry, provided the photoactive compound in the photoresist and the antireflective coating absorb at the exposure wavelength used for the imaging process.

To date, there are several major deep ultraviolet (uv) exposure technologies that have provided significant advancement in miniaturization, and these radiation of 248 nm, 193 nm, 157 and 13.5 nm. Photoresists for 248 nm have typically been based on substituted polyhydroxystyrene and its copolymers/onium salts, such as those described in U.S. Pat. No. 4,491,628 and U.S. Pat. No. 5,350,660. On the other hand, photoresists for exposure below 200 nm require non-aromatic polymers since aromatics are opaque at this wavelength. U.S. Pat. No. 5,843,624 and U.S. Pat. No. 6,866,984 disclose photoresists useful for 193 nm exposure. Generally, polymers containing alicyclic hydrocarbons are used for photoresists for exposure below 200 nm. Alicyclic hydrocarbons are incorporated into the polymer for many reasons, primarily since they have relatively high carbon to hydrogen ratios which improve etch resistance, they also provide transparency at low wavelengths and they have relatively high glass transition temperatures. U.S. Pat. No. 5,843,624 discloses polymers for photoresist that are obtained by free radical polymerization of maleic anhydride and unsaturated cyclic monomers. Any of the known types of 193 nm photoresists may be used, such as those described in U.S. Pat. No. 6,447,980 and U.S. Pat. No. 6,723,488, and incorporated herein by reference.

Two basic classes of photoresists sensitive at 157 nm, and based on fluorinated polymers with pendant fluoroalcohol groups, are known to be substantially transparent at that wavelength. One class of 157 nm fluoroalcohol photoresists is derived from polymers containing groups such as fluorinated-norbornenes, and are homopolymerized or copolymerized with other transparent monomers such as tetrafluoroethylene (U.S. Pat. No. 6,790,587, and U.S. Pat. No. 6,849,377) using either metal catalyzed or radical polymerization. Generally, these materials give higher absorbencies but have good plasma etch resistance due to their high alicyclic content. More recently, a class of 157 nm fluoroalcohol polymers was described in which the polymer backbone is derived from the cyclopolymerization of an asymmetrical diene such as 1,1,2,3,3-pentafluoro-4-trifluoromethyl-4-hydroxy-1,6-heptadiene (Shun-ichi Kodama et al Advances in Resist Technology and Processing XIX, Proceedings of SPIE Vol. 4690 p76 2002; U.S. Pat. No. 6,818,258) or copolymerization of a fluorodiene with an olefin (WO 01/98834-A1). These materials give acceptable absorbance at 157 nm, but due to their lower alicyclic content as compared to the fluoro-norbornene polymer, have lower plasma etch resistance. These two classes of polymers can often be blended to provide a balance between the high etch resistance of the first polymer type and the high transparency at 157 nm of the second polymer type. Photoresists that absorb extreme ultraviolet radiation (EUV) of 13.5 nm are also useful and are known in the art.

After the coating process, the photoresist is imagewise exposed. The exposure may be done using typical exposure equipment. The exposed photoresist is then developed in an aqueous developer to remove the treated photoresist. The developer is preferably an aqueous alkaline solution comprising, for example, tetramethyl ammonium hydroxide. The developer may further comprise surfactant(s). An optional heating step can be incorporated into the process prior to development and after exposure.

The process of coating and imaging photoresists is well known to those skilled in the art and is optimized for the specific type of resist used. The patterned substrate can then be dry etched with an etching gas or mixture of gases, in a suitable etch chamber to remove the exposed portions of the antireflective film, with the remaining photoresist acting as an etch mask. Various etching gases are known in the art for etching organic antireflective coatings, such as those comprising CF₄, CF₄/O₂, CF₄/CHF₃, or Cl₂/O₂.

Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

The refractive index (n) and the absorption (k) values of the antireflective coating in the Examples below were measured on a J. A. Woollam VASE32 ellipsometer.

The molecular weight of the polymers was measured on a Gel Permeation Chromatograph.

### EXAMPLES

### Example 1

A three-neck 500 mL round-bottom flask, equipped with a magnetic stirrer, thermometer and condenser, was charged with 136.1 g of 2-(3,4-epoxycyclohexyl)ethyl-trimethoxysilane (552 mmol), 68.0 g of phenyltrimethoxysilane (343 mmol), and 136.0 g of methyltrimethoxysilane (1.0 mol). To the flask, was added a mixture of 43.0 g of deionized water (DI) water, 18.0 g of acetic acid, and 127 g of isopropanol. The mixture was heated to reflux and kept at that temperature for 3 hours. Then, the mixture was cooled to room temperature. The solvents were removed under reduced pressure to afford 258.7 g of a colorless liquid polymer. The weight average molecular weight was approximately 7,700 g/mol, determined by gel permeation chromatography using polystyrenes as references.

### Example 2

A three-neck 250 mL round-bottom flask, equipped with a magnetic stirrer, thermometer and condenser, was charged with 35.00 g of 2-(3,4-epoxycyclohexyl)ethyl-trimethoxysilane (142 mmol), 8.50 g of phenyltrimethoxysilane (43 mmol), and 4.50 g of methyltrimethoxysilane (33 mmol). To the flask, was added a mixture of 5.90 g of DI water, 2.00 g of acetic acid, and 18 g of isopropanol. The mixture was heated to reflux and kept at that temperature for 3 hours. Then, the mixture was cooled to room temperature. The solvents were removed under reduced pressure to afford 41.0 g of a colorless liquid polymer. The weight average molecular weight was approximately 9,570 g/mol, determined by gel permeation chromatography using polystyrenes as references.

### Example 3

A three-neck 250 mL round-bottom flask, equipped with a magnetic stirrer, thermometer and condenser, was charged with 18.40 g of 2-(3,4-epoxycyclohexyl)ethyl-trimethoxysilane (75 mmol), 15.00 g of phenyltrimethoxysilane (76 mmol), and 46.40 g of tetraethoxysilane (223 mmol). To the flask, was added a mixture of 21.00 g of DI water, 4.00 g of acetic acid, and 82 g of propylene glycol monomethyl ether acetate. The mixture was heated to reflux and kept at that temperature for 3 hours. Then, the mixture was cooled to room temperature. The volatile components were removed under reduced pressure. The weight average molecular weight was approximately 6,900 g/mol, determined by gel permeation chromatography using polystyrenes as references.

### Example 4

A three-neck 250 mL round-bottom flask, equipped with a magnetic stirrer, thermometer and condenser, was charged with 35.0 g of 2-(3,4-epoxycyclohexyl)ethyl-trimethoxysilane (142 mmol), 8.5 g of phenyltrimethoxysilane (43 mmol), and 4.5 g of triethoxysilane (27 mmol). To the flask, was added a mixture of 5.9 g of deionized water (DI) water, 2.0 g of acetic acid, and 17 g of isopropanol. The mixture was heated to reflux and kept at that temperature for 3 hours. Then, the mixture was cooled to room temperature. The solvents were removed under reduced pressure to afford 41.98 g of a colorless liquid polymer. The weight average molecular weight was approximately 4,490 g/mol, determined by gel permeation chromatography using polystyrenes as references.

### Example 5

A three-neck 100 mL round-bottom flask, equipped with a magnetic stirrer, thermometer and condenser, was charged with 7.56 g of (3-glycidyloxypropyl)trimethoxysilane (32 mmol) and 1.89 g of trimethoxy(2-phenylethyl)silane (8 mmol). To the flask, was added a mixture of 1.09 g of deionized water (DI) water, 0.25 g of acetic acid, and 2.50 g of isopropanol. The mixture was heated to reflux and kept at that temperature for 5 hours. Then, the mixture was cooled to room temperature. The solvents were removed under reduced pressure to afford 4.21 g of a colorless liquid polymer.

### Example 6a

### Synthesis of N-phenyldiethanolammonium nonaflate.

3.021 grams of the amine was dissolved in 15 mL of CH₂Cl₂. This solution was added with cooling to a solution consisting of 5.00 grams of perfluorobutanesulfonic acid dissolved in 10 mL of water. After overnight stirring at room temperature the reaction mixture was stripped of solvents on a rotoevaporator and dried under high vacuum overnight to remove water. In this manner 7.5 grams of a slightly yellowish oil was recovered. The NMR spectra (H1 and C13) were consistent with desired component, and ion chromatography gave a single ionic compound having a retention time of 4.44 minutes. The differential scanning calorimenter (DSC) decomposition temperature of this material was 185° C.

### Example 6b

### Synthesis of N,N-diethyl 3-ammoniumphenol nonaflate.

2.753 grams of the amine was dissolved in 15 mL of CH₂Cl₂. This solution was added with cooling to a solution consisting of 5.00 grams of perfluorobutanesulfonic acid dissolved in 10 mL of water. After overnight stirring at room temperature the reaction mixture was stripped of solvents on a rotoevaporator and dried under high vacuum overnight to remove water. In this manner 4.3 grams of a dark oil was recovered. The NMR spectra (H1 and C13) were consistent with desired component, and ion chromatography gave a single ionic compound having a retention time of 4.8 minutes. The DSC decomposition temperature of this material was 153.5° C.

### Example 7

200 g of the epoxy siloxane polymer prepared in Example 1 and 7.0 g of diphenyliodonium perfluoro-1-butanesulfonate was dissolved in a mixture of propylene glycol monomethyl ether acetate (PGMEA) and propylene glycol monomethyl ether (PGME) (70/30 PGMEA/PGME) to achieve 6.3 wt. % of total solids and filtered. This homogeneous solution was spin-coated on a silicon wafer at 1200 rpm. The coated wafer was baked on hotplate at 250° C. for 90 seconds and the film thickness was. Then, n and k values were measured with a VASE Ellipsometer manufactured by J. A. Woollam Co. Inc. The optical constants n and k of the Si-containing film for 193 nm radiation were 1.668 and 0.180 respectively.

### Example 8

2.0 g of the epoxy siloxane polymer prepared in Example 2 and 0.04 g of diphenyliodonium perfluoro-1-butanesulfonate was dissolved in a mixture of propylene glycol monomethyl ether acetate (PGMEA) and propylene glycol monomethyl ether (PGME) (70/30 PGMEA/PGME) to achieve 6.2 wt % of total solids and filtered. This homogeneous solution was spin-coated on a silicon wafer at 1200 rpm. The coated wafer was baked on hotplate at 225° C. for 90 seconds. Then, n and k values were measured with a VASE Ellipsometer manufactured by J. A. Woollam Co. Inc. The optical constants n and k of the Si-containing film for 193 nm radiation were 1.728 and 0.209 respectively.

### Example 9

4.90 g of the epoxy siloxane polymer prepared in Example 2 and 0.10 g of N-phenyldiethanolammonium nonaflate from Example 6a was dissolved in a mixture of propylene glycol monomethyl ether acetate (PGMEA) and propylene glycol monomethyl ether (PGME) (70/30 PGMEA/PGME) to achieve 5.0 wt. % of total solids. This homogeneous solution was spin-coated on a silicon wafer at 1200 rpm. The coated wafer was baked on hotplate at 250° C. for 90 seconds. Then, n and k values were measured with a VASE Ellipsometer manufactured by J. A. Woollam Co. Inc. The optical constants n and k values of the Si-containing film for 193 nm radiation were 1.721 and 0.155, respectively.

### Example 10

2.0 g of the epoxy polymer prepared in Example 2 and 0.04 g of diphenyliodonium perfluoro-1-butanesulfonate was dissolved in a mixture of propylene glycol monomethyl ether acetate (PGMEA) and propylene glycol monomethyl ether (PGME) (70/30 PGMEA/PGME) to achieve 6.2 wt. % of total solids and filtered. This homogeneous solution was spin-coated on a silicon wafer at 1200 rpm. The coated wafer was baked on hotplate at 225° C. for 90 seconds to give a film thickness of 100 nm. Then, a layer of AZ® AX2120 photoresist (available from AZ® Electronic Materials, 70 Meister Avenue, Somerville, N.J.) was spin-coated and baked 100° C. for 60 seconds to give a 190 nm film over the cured antireflective layer. The photoresist was exposed at 193 nm with Nikon 306D and developed for 30 seconds at 23° C. in AZ® 300MIF developer. Lithographic evaluation showed good and clean 80 nm (1:1) line/space pattern with AZ® AX2120 photoresist at 22.5 mJ/cm² exposure energy.

### Example 11

One substrate coated with composition of Example 10 and another substrate coated with a photoresist AZ1120P (available from AZ Electronic Materials) were etched under conditions in Table I. The etch results were summarized in Table II. The etch rate of Si-containing bottom antireflective coating of the present invention was significantly lower than the photoresist.

TABLE I

| | |
|---|---|
| Etcher | NE-5000N(ULVAC) |
| Gas | Cl2/O2/Ar = 24/6/25 |
| RF Power (A/B) | 500 W/50 W |
| Process Pressure | 1.6 Pa |
| Wafer Temperature | 20° C. |
| Etch Time | 60 sec |
| Wafer | 8 inch |

TABLE II

| | | Etch Rate |
|---|---|---|
| | Etch Rate | relative to |
| Sample | (nm/min) | photoresist |
| AZ1120P | 170.6 | 1.00 |
| Example 11 | 33.8 | 0.20 |

1. An antireflective coating composition for a photoresist comprising an acid generator and a siloxane polymer, where the siloxane polymer comprises at least one absorbing chromophore and at least one self-crosslinkable functionality of structure (1), 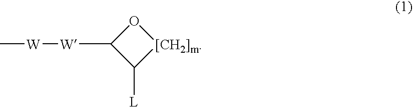
where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer.

2. The antireflective coating composition of claim 1, where the silicon content is greater than 15 weight %.

3. The antireflective coating composition of claim 1, where the self-crosslinkable functionality is selected from an epoxide and an oxetane.

4. The antireflective coating composition of claim 1, where the chromophore is selected from unsubstituted aromatic, substituted aromatic, unsubstituted heteroaromatic and substituted heteroaromatic moiety.

5. The antireflective coating composition of claim 1, where the chromophore is selected from substituted or unsubstituted phenyl group, unsubstituted anthracyl group, a substituted or unsubstituted phenanthryl group, a substituted or unsubstituted naphthyl group, a sulfone-based compound, benzophenone-based compound, a substituted or an unsubstituted heterocyclic aromatic ring containing heteroatoms selected from oxygen, nitrogen, sulfur; and a mixture thereof.

6. The antireflective coating composition of claim 1, where the siloxane polymer comprises at least units of (i), and/or (ii), of the structure,
—(R¹SiO_{3/2})— and —(R²SiO_{3/2})— (i),
—(R′(R″)SiOx)— (ii),
where R¹ is independently a moiety comprising a self-crosslinking group of structure (1), R² is independently a moiety comprising a chromophore group, R′ and R″ are independently selected from R¹ and R², and x=½ or 1.

7. The antireflective coating composition of claim 6, where the polymer further comprises one or more units selected from,
—(R³SiO_{3/2})— (v),
where R³ is independently, hydroxyl, hydrogen, halide (such as fluoride and chloride), alkyl, OR, OC(O)R, alkylketoxime, aryl, alkylaryl, alkoxy, acyl and acyloxy, and R is selected from alkyl, unsubstituted aryl and substituted aryl,
—(SiO_{4/2})— (vi),
—((A¹)A²SiOx) (vii),
where x=½ or 1, A¹ and A² are independently hydroxyl, hydrogen, halide (such as fluoride and chloride), alkyl, OR, OC(O)R, alkylketoxime, aryl, alkoxy, alkylaryl, acyl and acyloxy; and mixtures of these units.

8. The antireflective coating composition of claim 1, where the siloxane polymer comprises at least units of (iii), and (iv), of the structure,
—(A¹R¹SiOx)— (iii), and
—(A²R²SiOx)— (iv),
where, R¹ is independently a moiety comprising a self-crosslinking group of structure (1), R² is independently a moiety comprising a chromophore group, x=½ or 1, A¹ and A² are independently hydroxyl, R¹, R², halide (such as fluoride and chloride), alkyl, OR, OC(O)R, alkylketoxime, unsubstituted aryl and substituted aryl, alkylaryl, alkoxy, acyl and acyloxy, and R is selected from alkyl, unsubstituted aryl and substituted aryl.

9. The antireflective coating composition of claim 1, where the siloxane polymer comprises at least one unit of structure (v),
(R⁵SiO_{3/2}) (v),
where R⁵ is a moiety comprising a self-crosslinking group of structure (1) and an absorbing chromophore.

10. The antireflective coating composition of claim 1, where the polymer comprises structure,
(R¹SiO_{3/2})ₐ(R²SiO_{3/2})_{b}(R³SiO_{3/2})_{c}(SiO_{4/2})_{d}
where, R¹ is independently a moiety comprising a self-crosslinking group of structure (1), R² is independently a moiety comprising a chromophore group, R³ is independently, hydrogen, (C₁-C₁₀)alkyl, unsubstituted aryl, and, substituted aryl radical,
0<a<1; 0<b<1, 0≦c<1; 0≦d<1.

11. The antireflective coating composition of claim 1, where the self-crosslinking group is a cycloaliphatic epoxide.

12. The antireflective coating composition of claim 1, where the acid is a thermal acid generator.

13. The antireflective coating composition of claim 1, where the acid is selected from an iodonium salt, sulfonium salt and ammonium salt.

14. The antireflective coating composition of claim 1, further comprising a solvent.

15. The antireflective coating composition of claim 1 free of a crosslinking agent and/or dye.

16. A process for imaging a photoresist comprising the steps of,
a) forming a antireflective coating from an antireflective coating composition of claim 1 on a substrate;
b) forming a coating of a photoresist over the antireflective coating
c) imagewise exposing the photoresist with an exposure equipment; and,
d) developing the coating with an aqueous alkaline developer.

17. The process according to claim 1 where radiation for imagewise exposure is selected from 248 nm, 193 nm, 157 nm and 13.5 nm.

18. The process according to claim 1 where the developer is an aqueous solution of tetramethyl ammonium hydroxide.

19. A siloxane polymer, where the siloxane polymer comprises at least one absorbing chromophore and at least one self-crosslinking functionality of structure (1). 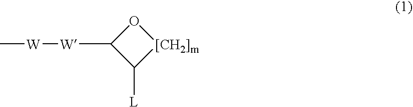
where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer.

20. The polymer of claim 19, where the polymer comprises at least units of (i), and/or (ii), of the structure,
—(R¹SiO_{3/2})— and —(R²SiO_{3/2})— (i),
—(R′(R″)SiOx)— (ii),
where R¹ is independently a moiety comprising a self-crosslinking group of structure (1), R² is independently a moiety comprising a chromophore group, R′ and R″ are independently selected from R¹ and R², and x=½ or 1.

21. The polymer of claim 19, where the siloxane polymer comprises at least units of (iii), and (iv), of the structure,
—(A¹R¹SiOx)— (iii), and
—(A²R²SiOx)— (iv),
where, R¹ is independently a moiety comprising a self-crosslinking group of structure (1), R² is independently a moiety comprising a chromophore group, x=½ or 1, A¹ and A² are independently hydroxyl, R¹, R², halide (such as fluoride and chloride), alkyl, OR, OC(O)R, alkylketoxime, unsubstituted aryl and substituted aryl, alkylaryl, alkoxy, acyl and acyloxy, and R is selected from alkyl, unsubstituted aryl and substituted aryl.

22. The polymer of claim 19, where the siloxane polymer comprises at least one unit of structure (viii),
(R⁵SiO_{3/2}) (viii),
where R⁵ is a moiety comprising a self-crosslinking group of structure (1) and an absorbing chromophore.
